(19) United States
(12) Patent Application Publication
(10) Pub. No.: US 2006/0259443 A1
(43) Pub. Date: Nov. 16, 2006

(54) Systems engineering parametric cost model

(75) Inventors: Ivan J. Vincenzini, Cypress, CA (US); Michael N. Ernstoff, Los Angeles, CA (US); Leif R. De Wolf, La Habra, CA (US)

Correspondence Address: Leonard A. Alkov, Esq.;Raytheon Company, P.O. Box 902 (E4/N119), El Segundo, CA, 90245-0902, US

(73) Assignee: Raytheon Company

(21) Appl. No.: 11/139,757

(22) Filed: May 27, 2005

(51) Int. Cl. G06F 17/00

(52) U.S. Cl. 705/400

(57) ABSTRACT

A method for estimating the cost of completion at the end of a first time interval of a new program uses a plurality of tasks, program phases and new elements. The estimation steps require making an initial cost allocation for each task within the new program. Then, tailoring the cost allocation for the program phases to obtain a normalized value. Subsequently, compute a schedule aggressiveness; a requirements volatility; and a complexity, where the complexity identifies new elements within the new program. Next, combine the normalized value, the schedule aggressiveness, the requirements volatility, and the complexity to extrapolate an end cost for each of the tasks from the initial allocation for the end of the first interval. After summing the end cost for each of the tasks to obtain a first value, adjusting the first value using a resource needs ratio and a calibration factor to arrive at an estimated cost of completion of the new program at the end of the first interval.

### BACKGROUND OF THE INVENTION

1. Field of Invention

This invention is in the field of parametric models for estimation of cost to completion of development programs having complex hardware and software components.

2. Description of the Related Art

Estimation of total cost to completion of development programs requiring the design and implementation of complex hardware and software as well as their integration is necessary for program bidding, planning and execution. Historically, there has been an attempt at using a bottoms up approach at estimating the cost of new development programs from prior experience with completed programs. The prior experience of engineers doing similar programs was used to arrive at a cost estimate. As the complexity of programs increases, the results generated by prior art methods have not been sufficiently accurate.

Generally no consistent methods are known for treating each variable, looking at its relevance in the context of a complex program, then using these variables for estimating the overall cost of a completed program based on changes as applicable for a yet to be built system. This lack of a methodical approach to the estimation of total costs for a new program has introduced errors and inaccuracies in the estimation process reducing its overall utility.

### SUMMARY OF THE INVENTION

The limitations of prior cost estimations are reduced by a method for estimating the cost of completion at the end of a first time interval of a new program using a plurality of tasks for completion of said new program, said new program having program phases and new elements. The method comprises the steps of:

making an initial cost allocation for each of said tasks within said new program;

tailoring said cost allocation for said program phases to obtain a normalized value;

computing a schedule aggressiveness;

computing a requirements volatility;

computing a complexity, said complexity identifying new elements within said new program;

combining said normalized value, said schedule aggressiveness, said requirements volatility, and said complexity to extrapolate an end cost for each of said tasks for said new program from said initial allocation, said end cost estimated for the end of said first interval;

summing said end cost for each of said tasks to obtain a first value,

adjusting said first value using a resource needs ratio and a calibration factor to arrive at an estimated cost of completion of said new program at the end of said first interval.

For example, the tasks to be used for estimation purposes comprise one or more chosen among a Management plan, a System design, a System analysis, a Specification and interface, a Status Report and Revisions, an Assembly, Instrumentation and Test Requirements Plans and Procedures, a Test Equipment Facilities and Delivery, an Assembly Integration and Test, a Validation, and a Post Delivery and Support.

### BRIEF DESCRIPTION OF THE DRAWING

In the Drawing:

FIG. 1 shows the cost engine of the estimation method described herein containing the factor multiplier table;

FIG. 2 shows the miscellaneous inputs to the cost engine;

FIG. 3 shows the impact of schedule slip within a schedule aggressiveness computation;

FIG. 4 shows other component used within the schedule aggressiveness computation;

FIG. 5 shows the initial allocation and tailoring flow chart applicable to this invention;

FIG. 6 shows the product re-use chart

FIG. 7 shows the computation of volatility applicable to this invention;

FIG. 8 shows the complexity matrix applicable to this invention;

FIG. 9 shows the calibration factor applicable to this invention; and

FIG. 10 shows application of the resource needs ratio to the cost engine described in FIG. 1.

### DETAILED DESCRIPTION

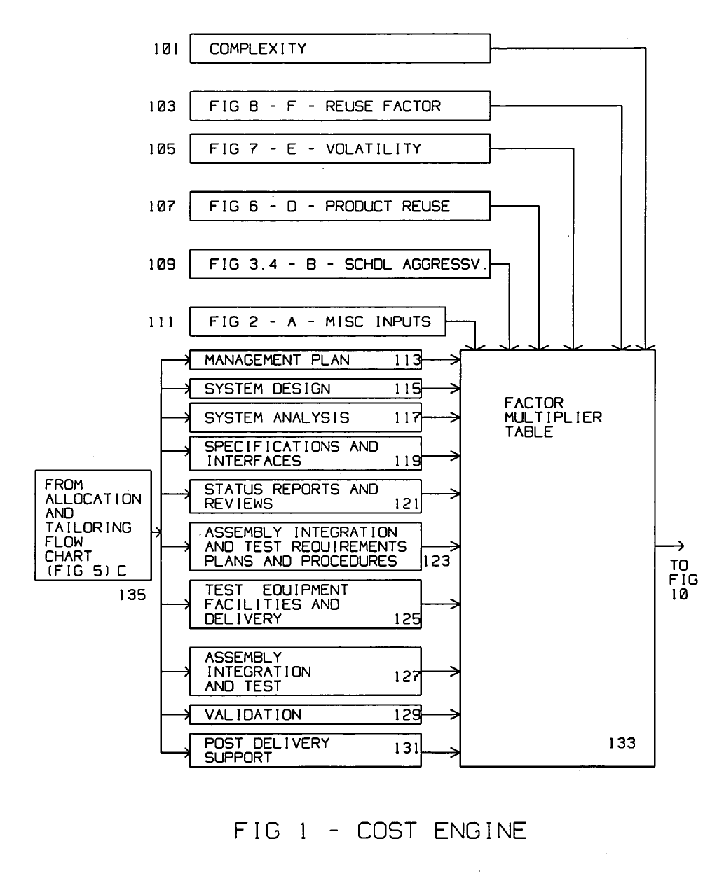

This invention describes a method for estimating the cost of completion of a new program. The program has hardware/software, systems development, new and old systems/subsystems (elements). The estimated cost of completion of the new program is computed for the end of a time interval of the new program. A plurality of tasks need to be completed for said new program. The new program also has program phases. Some of the new elements can be derived or be based on old, existing elements from an old, previous program. The tasks to be completed are identified at the start of the cost estimation process. The overview of the method for estimating the cost of completion of a new program is shown in FIG. 1.

The first step is identifying particular tasks relevant to the new program, including those based on old programs having similar characteristics. A typical, exemplary list of such tasks, relevant to a major program are the following 10, as detailed in FIG. 1. These tasks will be used for tracking and estimating the progress of the new program in light of existing and new elements.

Management plan 113—the plan necessary to arrive at the new program from a management perspective. Management plan 113 describes the method for identifying, allocating and scheduling the resources necessary to develop and deliver the various products of systems engineering. The structure of management plan 113 is such that it does not contain detailed plans, such as a test plan, but rather indicates how and by who such plans are to be prepared, reviewed and approved. The cost of the management plan product includes the cost of the associated intellectual efforts and not just publication costs.

System design 115—the system design for the overall system. System design 115 is defined as an intellectual product that typically involves using text and drawings to describe interfaces between system components and the performance of the new system.

System analysis 117—analysis of the system design generated by system design 115. System analysis 117 is defined as part of the systems engineering process where numerous aspects of the system are analyzed in detail as part of an iterative process for evaluating alternatives, estimating system performance, cost, and risk. System analysis 117 also is used to look for early signs of potential problems and develop alternative solutions for problem areas. Each system analysis is generally limited in scope and duration.

Specification and interface 119—definition of interfaces between subsystems, part of the new system. Specification for each hardware and software component within the new system, and with the outside world. The specification and interface 119 delineate the design parameters of the system from the point of view of interaction internally as well as external to the system forming the new program. It includes deliverables such as hardware/software specifications, interface control documents, indexes, notices, and drawings that are not specified elsewhere, as for example, certain test related items. The cost of specifications and interfaces 119 includes for example:

i) the cost of assembling the content,

ii)communicating each specification to all interested parties and negotiating compromises when required,

iii) controlling the configuration of the specification and

iv) publishing the physical document including type setting, illustrating and reproduction costs.

Status Report and Reviews 121—generating status reports on the progress towards the new system and conducting management/customer reviews. Provides the customer and management with a window on new program activities. Distinct from the design, analysis and test products, do not include performance data typically present in design and analysis. This task includes:

i) assembling, checking for consistency and correctness reformatting and publishing technical details descriptive of the new system,

ii) providing expert review of the status reports prior to presentation

iii) following up on action items generated during the review process.

Typically, does not include the intellectual effort provided by the technical specialities, such as engineering.

Assembly, Instrumentation and Test Requirements plans and procedures 123—generating test sequences and instrumentation required for validating the operation of hardware and software components. Specifies unit, subsystem, and system wide functional and environmental test requirements as well as operational test requirements.

Test Equipment facilities and delivery 125—details the cost of new or reconfigured buildings to meet special requirements for the new program not satisfied by generic, existing facilities. It includes, for example, special test equipment specific to the new program, shipping containers where applicable, to conduct new system tests. It further contains the intellectual efforts necessary for determining how and what test equipment should be built, specifying requirements and design, as well as the effort associated with acquiring the equipment, (such as fabrication, assembly and transportation of test equipment), validation and calibration of the test equipment and maintaining it operational. Facility related products include the intellectual efforts to specify and justify building new facilities or reconfigure existing facilities to meet special requirements of the new program. Delivery related tasks identify, design and fabricate special delivery equipment required by the new program, as well transportation to customer's site.

Assembly integration and test (AI&T) 127—completing assembly of program components and test thereof. This is the step that leads to the physical manufacture of products related to the new program. The outputs generally are records of activities, test data, engineering test proposals and improved hardware suggestions. The cost includes the cost of generating the test data, performing the test, excluding the cost of rented test equipment or expendable materials which are part of Test Equipment.

The functional tests performed as part of AI&T are not considered validation or verification testing. Functional tests describe a test incidental to the assembly of the hardware. In contrast, validation testing is performed under specifically controlled conditions.

The cost of originating engineering change proposals is considered part of AI&T and is not separately priced. The preparation and evaluation of engineering change proposals is included under Specification and Interfaces 119.

Validation 129—comparing the operation of the assembled new system with system design 115 and system analysis 117. Validation confirms that the new system, part of the new program, meets requirements. Validation costs include performing the Validation activity (including, if necessary, the cost to monitor the equipment for three shifts a day, seven days a week), analyzing the results as well as the cost of publishing and distributing the resulting document(s).

Post delivery and support 131—efforts required to support customers after the sale. Includes those products whose development can not be efficiently undertaken until after the system within the new program has been installed in its intended application. In space and strategic applications, post delivery support may take the form of developing and delivering mission requirements, specifications, plans and procedures that reflect the as delivered system/new program capabilities. In tactical applications, post-delivery support may take the form of uncovering, resolving and documenting changes necessary for the system to work effectively within larger system or framework whose configuration may not be fully stable with time, i.e. the exact final configuration is still being developed, and had not been fully known at the time of design of the (present) new program.

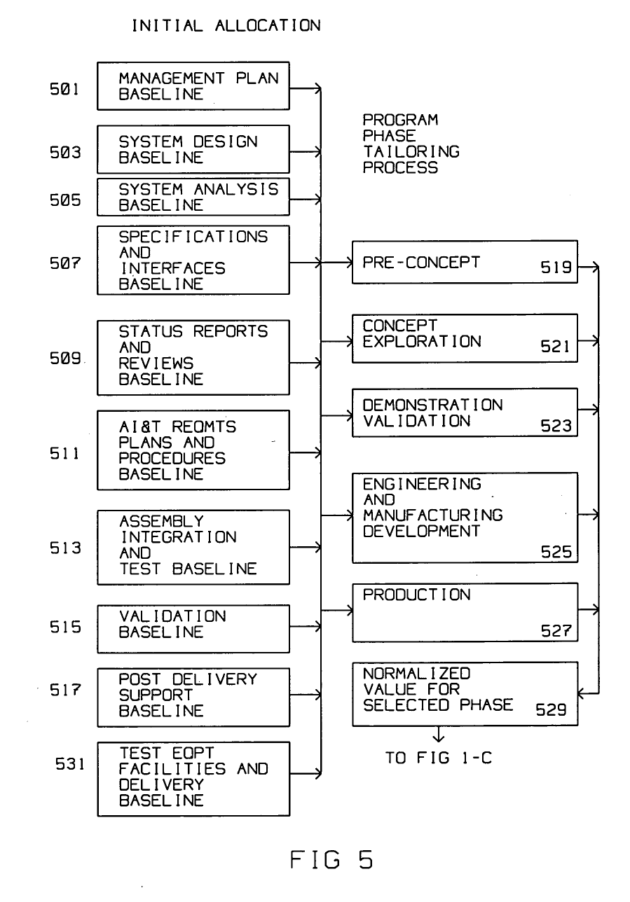

The initial allocation and tailoring flow chart for baseline tasks for a new program are exemplified in FIG. 5. An initial dollar allocation is made for

Management plan baseline 501,

System design baseline 503,

System analysis baseline 505,

Specification and interface baseline 507,

Status Report and Revisions baseline 509,

Assembly, Instrumentation and Test Req's plans and procedures baseline 511,

Test Equipment facilities and delivery baseline 531,

Assembly integration and test baseline 513,

Validation baseline 515, and

Post delivery and support baseline 517.

As further detailed in FIG. 5, each of above baselines is tailored and estimated for a particular program phase. Each of items 501 through 517 is modified by inputs generated by the program phase tailoring process. The phases are:

Pre-concept 519—initial, pre-concept exploration of new program outlines;

Concept exploration 521—further detail of the concepts involved in the new program;

Demonstration validation 523—small scale validation of the overall new program, first prototype construction;

Engineering and manufacturing development 525—Preparation for production; and

Production 527—production of new program hardware/software and integraton thereof in a working whole.

The results from each program phase are normalized for each selected program phase 529 to account for the particular stage of the program being estimated. For example, the pre-concept 519 stage will require far fewer resources than production 527.

The estimation process uses values from initial allocation 501-517, 513 modified for each program stage 519, 521, 523 525 and/or 527 to arrive at an applicable dollar result. This dollar result, generated in 529 is sent to FIG. 1 for further estimation. Thus, for each program stage, 519-527, a separate normalized value will apply as the program progresses. The total cost of the program is the sum of all costs incurred/projected as each stage is traversed. The dollar results are propagated through the cost engine 133 of FIG. 1 and subsequent steps.

Further as detailed in FIG. 1, the factor multiplier table 133 also takes into consideration:

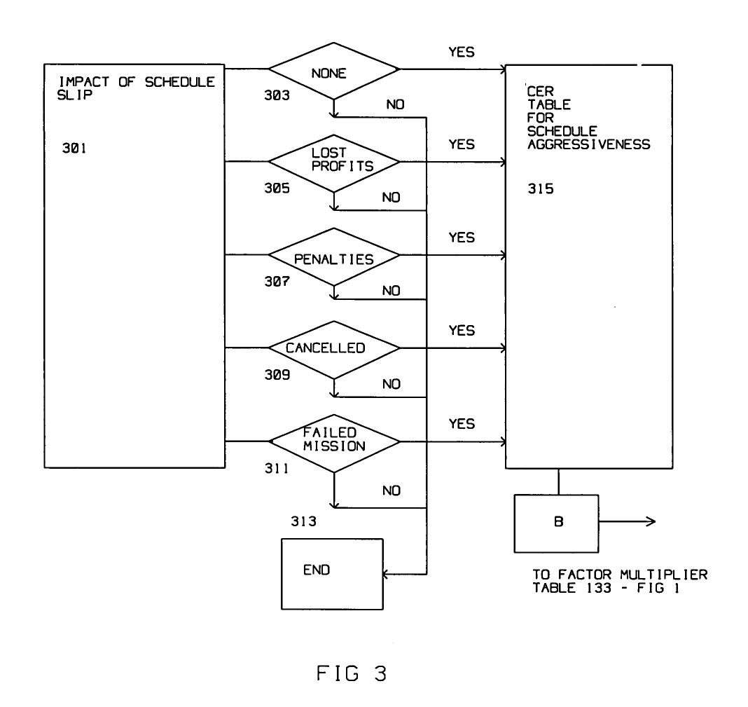

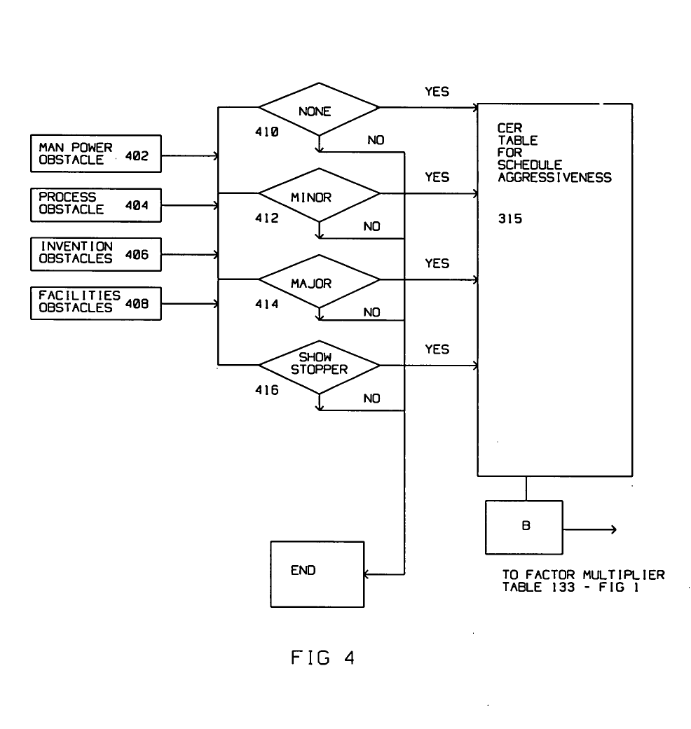

computing a schedule aggressiveness 109 per FIG. 3 and FIG. 4;

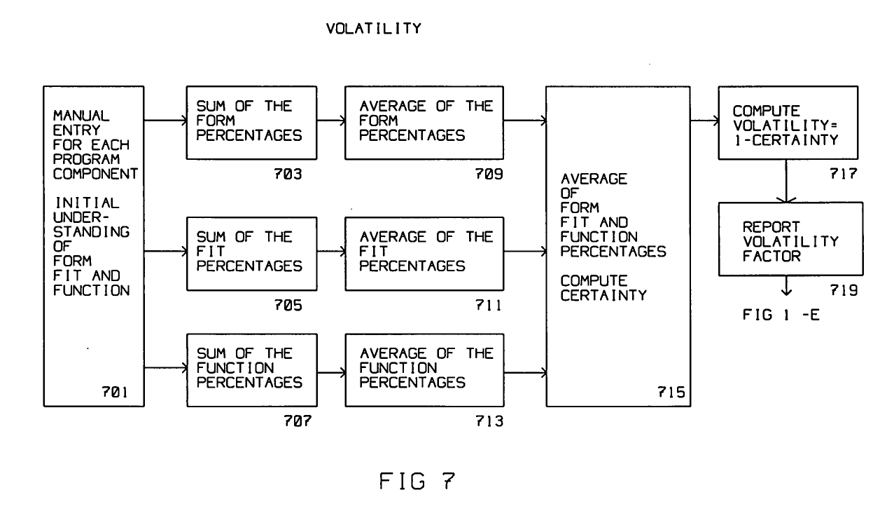

computing a requirements volatility 105 per FIG. 7;

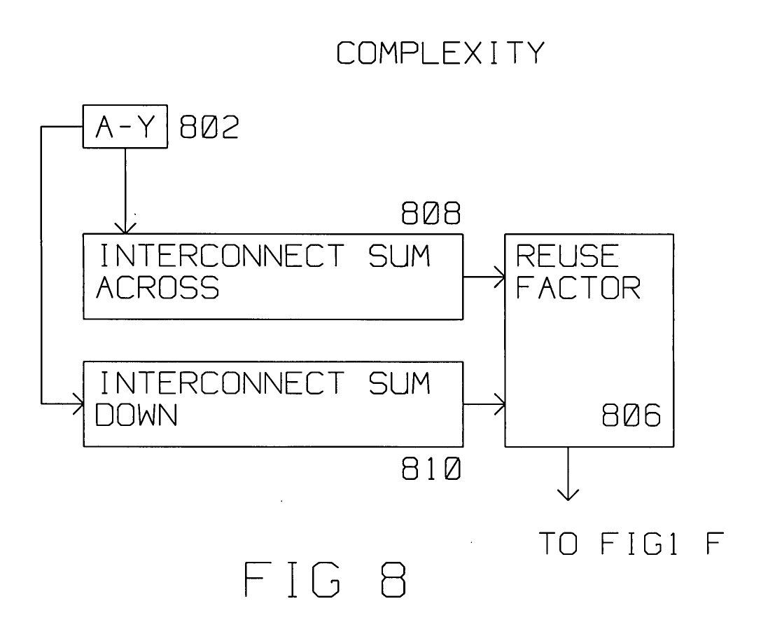

computing a complexity 101 per FIG. 8;

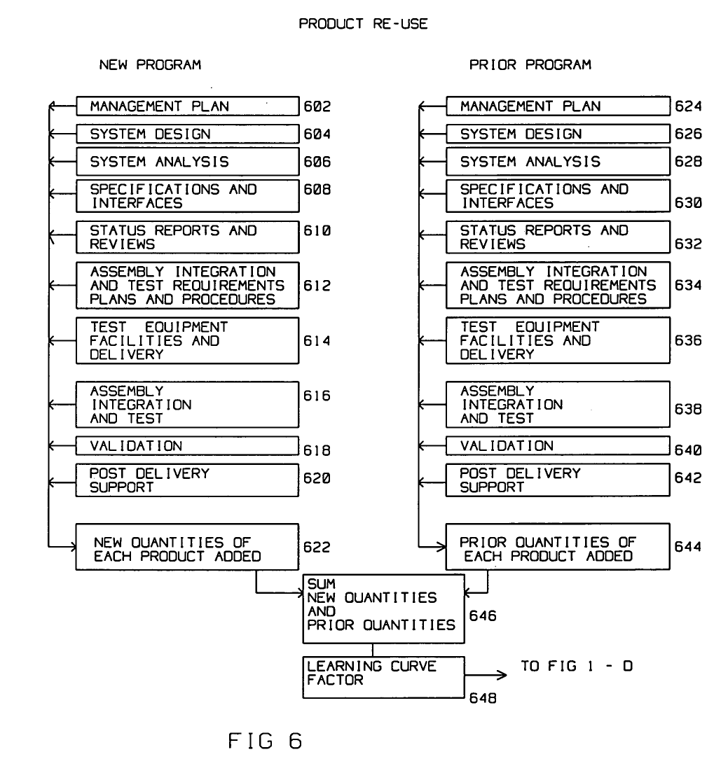

computing a product reuse 107 from the identification of new elements within said new program to be derived from prior, existing elements per FIG. 6; and

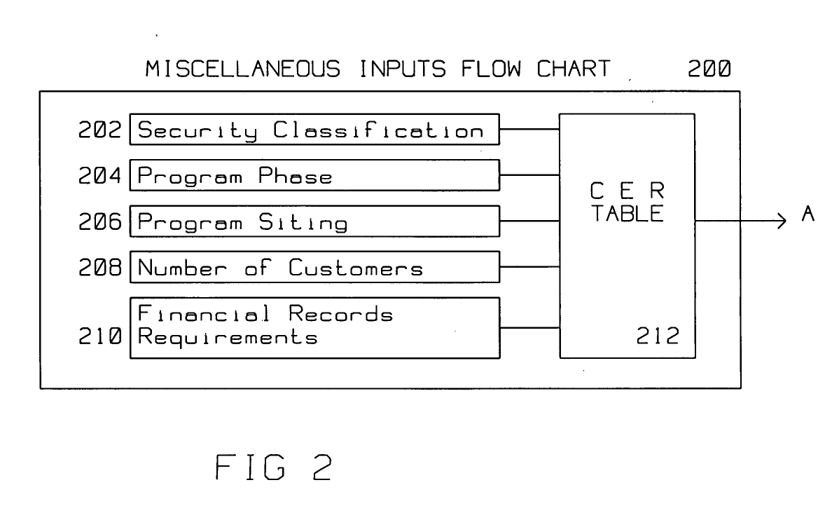

generating a miscellaneous inputs 111 per FIG. 2.

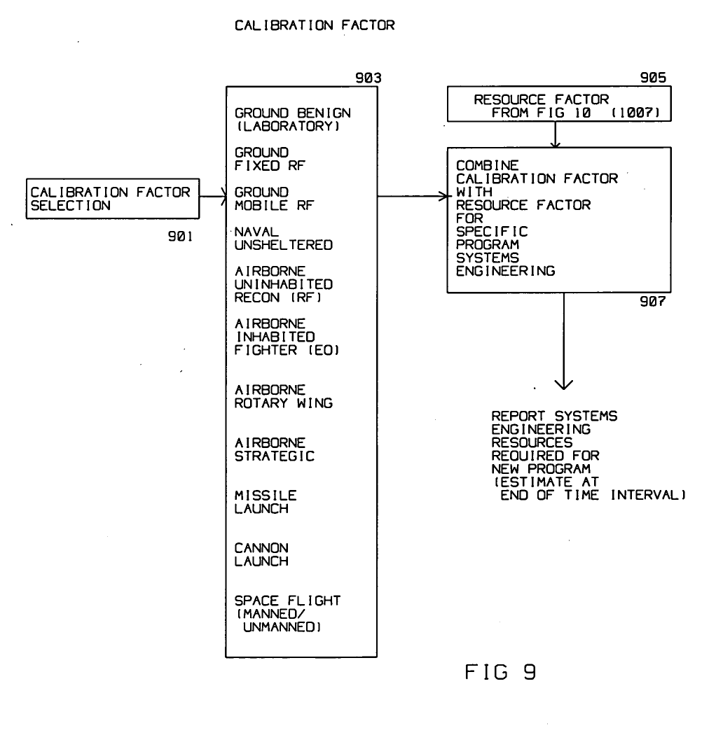

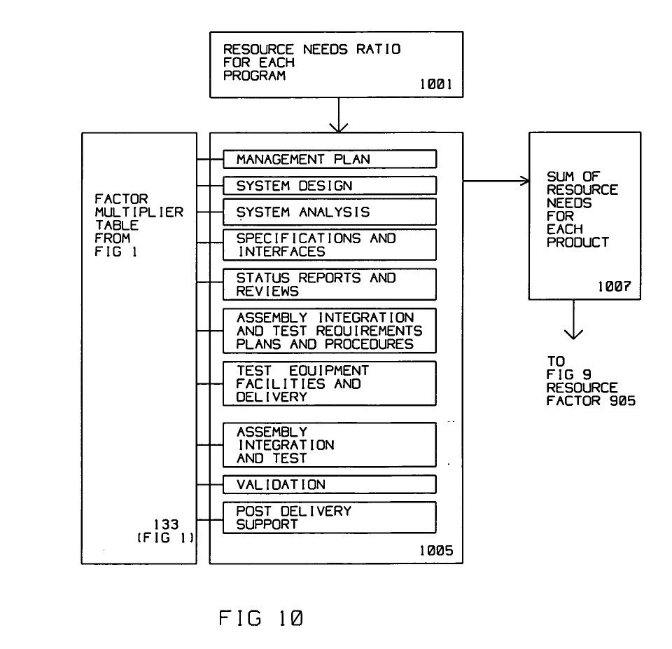

The factor multiplier table 133 in FIG. 1 combines said normalized value, said schedule aggressiveness, said requirements volatility, said complexity to extrapolate an end cost after an interval for each of said tasks for said new program from said initial allocation, said end cost estimated for the end of the first interval. Summing the end cost for each of the tasks generates a total to be adjusted by the resource needs ratio for each program 1001 of FIG. 10. The output from the resource needs ratio is further adjusted by a calibration factor 901 in FIG. 9. This yields the system engineering resources estimated for the completion of said new program at the end of said first interval.

The results after each program stage 519-527 are tested to validate the results from previous steps as the program progresses. Parameters present in factor multiplier table 133 are adjusted to better reflect progress to date. This provides a feedback path and identifies the degree of reliability from projections.

The factor multiplier table 133 contains an entry for each of the above cited elements 101 to 111. For a typical program estimation, the factor multiplier table 133 has typically exemplary entries shown in table 1A and 1B.

Management plan 113 is a dollar value that is associated with the cost of plan management for the new program over the interval of interest. Similarly, system design 115, is also a dollar value of the cost of system design for the new system over the interval of interest System analysis 117, specification and interfaces 119 status reports and reviews 121 AI& T requirements plans and procedures 123, Test equipment facilities and delivery 125, Assembly integration and test 127, Validation 129, and Post delivery and support 131 are dollar values associated with that particular task within the program. Each of these is operated upon by six factors derived from prior experience and applied within factor multiplier table 133.

The six factors considered in table 1 are Complexity 101, Reuse factor 103, Volatility 105, Product Re-use 107, Schedule Aggressiveness 109, and miscellaneous inputs 111, further detailed below.

1) Complexity

Complexity 101—related to how complex the new system is as compared to the previous system. This factor has a value of more than 1 for systems more complex than their predecessors. Where a new system is more streamlined that the old, having fewer subsystems, the value for complexity can be less than 1. An increase in number of sub-systems will increase complexity.

As shown in FIG. 8, Complexity is derived by setting up a matrix using the interconnect-diagram of the system(s), part of the new program. For example, for a matrix having system elements A-Y by A-Y representative of the program/system(s) interconnect diagram, variables A-Y 802 are summed across the columns of the matrix in interconnect sum 808 across. The same variables A-Y are summed down, along the rows, in interconnect sum down 810. The results of these two summations are sent to Reuse factor 806. The output from Reuse factor 806 is sent to FIG. 1, (f).

2) Reuse Factor

Reuse factor 103—related to what portion for particular tasks 113-131 of the new program can be extracted from an old program, and the learning curve related to it. Typically a value of 1.0 as it is likely most elements of an old program would be applicable to a new program. The re-use factor is detailed in FIG. 6. Here new program management plan 602, system design 604, system analysis 606, specification and interfaces 608, status reports and reviews 610, AI& T requirements plans and procedures 612, Test equipment facilities and delivery 614, Assembly integration and test 616, Validation 618, and Post delivery and support 620 are summed into New quantities of each product added 622 and compared to prior program quantities. Prior program management plan 624, system design 626, system analysis 628, specification and interfaces 630, status reports and reviews 632, AI& T requirements plans and procedures 634, Test equipment facilities and delivery 636, Assembly integration and test 638, Validation 640, and Post delivery and support 640 are summed into Prior quantities of each product added 644 to generate a total amount of the existing, prior program known systems/subsystems.

The result from 644 and 622 form the Sum of New Quantities and prior quantities 646. The are adjusted by a learning curve factor 648 and presented to the factor multiplier table 133 in FIG. 1.

Typically, the re-use factor detailed in FIG. 6 is defined as the percentage decrease of the required resources due to previous experience with similar system components.

3) Volatility

Volatility 105—related to how well known the requirements for the new program are at the start of the program, and as it progresses towards completion.

Volatility 105, as detailed in FIG. 7, is the measure of change in requirements for a given program. Numerically, volatility ranges from 0 to 1, and is measured by estimating the form, fit and function of each subsystem part of the new program. When requirements are fixed, and unlikely to change, volatility is set at 0. Thus the contribution to future costs due to unplanned requirement changes will also be zero. Volatility is dependent on program complexity, as well as the form, fit and function of the new program. For example,

$$Form = {C}_{m} \frac{80 \% * 2.1 + 80 \% * 4.5 + …}{2.1 + 4.5 + …}$$

where Cₘ is the relative role of form. The 80% means there is an 80 percent chance the system requirements will not change.

Volatility is defined as 1—Certainty where certainty is
Certainty=Σ(Form+Fit+Function)

Volatility affects each variable of column 2 of table 1A and 1B.

As detailed in FIG. 7, the computation and subsequent Reporting Volatility Factor 719 starts with the manual entry of each program task 113-131 and an initial understanding of a form parameter, a fit parameter and a function parameter 701 as applicable to each task. Sum of the form percentages parameter 703 is computed along with the averages of the form percentages 709. Sum of the fit percentages parameter 705 is computed along with the averages of the fit percentages 711. Sum of the function percentages parameter 707 is computed along with the averages of the function percentages 713. The average of form, fit and function are used to compute certainty 715. Volatility is computed in 717 from 1—Certainty. Volatility is reported for use within factor multiplier table 133.

4) Product Reuse

Product Reuse 107—related to how many existing products can be used by the new program, instead of having to develop new products. This value is typically 1 as it is likely a new program can be constituted from, or re-use a plurality of old products.

5) Schedule Aggressiveness

Schedule aggressiveness 109—related to how ambitious the schedule for completion is as compared to old programs. Further detailed in FIG. 3, and FIG. 4. Items considered are the impact of schedule slip 301, manpower requirements (availability of skilled personnel to bring the system to completion), fixed plant facilities, length of time to complete the program, and the element of invention. Invention refers to what new, never before designed subsystems are required by the new program. These new sub-systems have yet to be invented, and represent a high risk.

FIG. 3 is an example as to how impact of schedule slip 301 is computed to arrive at an entry into factor multiplier table 133 if FIG. 1. Decision box NONE 303 ascertains using a query to the user whether there is any impact from schedule slip. If so, an entry is activated in the Cost Estimation Relationships (CER) table for Schedule aggressiveness 315. Similarly, Lost profits 305, if relevant, activates an entry in table 315. Penalties 307, if part of the contract, are recognized andactivate another entry in table 315. If there is a risk of program cancellation, that possibility is recognized in logic box Cancelled 309, activating an entry in table 315. Furthermore, failed mission 311 activates an entry in table 315 if there is a chance of mission failure. The combination of the variables entered into table 315 are transmitted to Factor multiplier table 133 in FIG. 1.

Other entries in table 315 are shown in FIG. 4. Here, Man Power Obstacle parameter 402, a measure of availability of qualified personnel to complete the enumerated tasks for completion of the new program, is further processed depending on the degree of difficulty it presents. For example, if manpower obstacle parameter 402 presents no difficulty, then logic box NONE 410 provides an entry in table 315. If the difficulty is minor, the logic box MINOR 412 makes an entry into table 315. If the difficulty is major, then logic box MAJOR 414 provides further input to table 315. Finally, if Man Power Obstacle 402 is perceived as extremely critical, logic box SHOW STOPPER 416 will reflect this case as an entry in table 315.

The same logic queries are applied using Process Obstacle parameter 404. Process refers to the design process for designing the parts of the new program.

Invention obstacle parameter 406, similarly treated, identifies the possibility of as yet undeveloped parts of the new program wherein an invention effort has to create these parts. This is separate and distinct from the typical design effort where known methods and techniques can be applied to meet a set or requirements.

Facilities Obstacles parameter 408 refers to the availability of facilities for use by the new program. If required facilities are special in nature, in high demand, or otherwise present an obstacle, entries in table 315 are made depending on the nature of the obstacle, as defined by logic boxes 410, 412, 414 and 416.

6) Miscellaneous Inputs

Miscellaneous inputs—111—related to other characteristics of the new program. Details in FIG. 2. One aspect is security classification 202 (the more secret a program is, the more costly). Another is program phase 204, related to which program phase is being currently estimated. Program siting 206 is also a consideration, as a site not in the US can add substantial costs. Number of customers 208 is indicative of how many other organizations will be using the results of the new program. A large number of customers is desirable as it allows amortization or new program cost over a larger customer base. Finally, financial records requirements 210 is also included to account for costs associated with financial transactions incurred for the new program. Each of items 202, 204, 206, 208 and 210 is input into Cost Estimation Relationship (CER) table 212 to obtain a factor to be used in factor multiplier table 133.

As shown in FIG. 10, the output from factor multiplier table 133 combines with resource needs ratio for each program 1001 for each of component in list 1005, namely management plan, system design, system analysis, specification and interfaces, status reports and reviews, AI& T requirements plans and procedures, Test equipment facilities and delivery, Assembly integration and test, Validation, and Post delivery and support. Each of these modified quantities in list 1005 is summed in Sum resource needs for each product 1007 to generate a resource factor

As shown in FIG. 9 the resource factor 905 (derived from from 1007 in FIG. 10) is combined with a calibration factor in Combine Calibration Factor with Resource Factor for Specific Program Systems Engineering 907 to generate the overall system engineering resources required for the new program. The calibration factor selection 901 is applied from a set of choices 903. The choices are listed in table 2, and indicate the type of new program and its relative calibration factor selection.

FIG. 5 shows the initial allocation and program phase tailoring process. The initial allocation, or starting condition for a particular program to be modelled is defined for:

Management plan 501

System design baseline 503

System analysis baseline 505

Specification and interfaces baseline 507

Status reports and revisions baseline 509

AI&T requirements plans and procedures baseline 511

Assembly, integration and test 513

Validation baseline 515

Post Delivery and support baseline 517

The same definitions previously given apply, except that 501-517 are initial baselines to be later modified during the estimation cycle at the start/end of each time interval.

All references cited in this document are incorporated herein by reference in their entirety.

Although presented in exemplary fashion employing specific embodiments, the disclosed structures are not intended to be so limited.

Those skilled in the art will also appreciate that numerous changes and modifications could be made to the embodiment described herein without departing in any way from the invention. These changes and modifications and all obvious variations of the disclosed embodiment are intended to be embraced by the claims to the limits set by law.

TABLE 1 A
Typical Sample Factor Multiplier Table 133 Entries
Reference FIG. 1

| | Complexity | Reuse factor | Volatility |
|---|---|---|---|
| Management plan 113 | 1.3 | .98 | .86 |
| System design 115 | 1.3 | .98 | .86 |
| System analysis 117 | 1.3 | .98 | .86 |
| Specification and intfc. 119 | 1.3 | .98 | .86 |
| Status Rep and Reviews 121 | 1.3 | .98 | .90 |
| AI& T Req plans and proc. 123 | 2.2 | .98 | .90 |
| Test Eqpt faclt. and del. 125 | 1.8 | .98 | .90 |
| Assembly int. and test 127 | 1.8 | .98 | .90 |
| Validation 129 | 1.4 | .98 | .90 |
| Post delivery and supprt 131 | 1.3 | .98 | .90 |

TABLE 1 B
Typical Sample Factor Multiplier Table 133 Entries
Reference FIG. 1

| | Product | Schedule | Misc |
|---|---|---|---|
| | Reuse | Aggressiveness | Inputs |
| Management plan 113 | 1.0 | 1.7 | .40 |
| System design 115 | 1.0 | 1.7 | .40 |
| System analysis 117 | 1.0 | 1.75 | .40 |
| Specification and intfc. 119 | 1.0 | 1.75 | .40 |
| Status Rep and Reviews 121 | 1.0 | 1.80 | .40 |
| AI& T Req plans and proc. 123 | 1.0 | .80 | .90 |
| Test Eqpt faclt. and del. 125 | 1.0 | .90 | .90 |
| Assembly intgr. and test 127 | 1.0 | .90 | .90 |
| Validation 129 | 1.0 | .90 | .90 |
| Post delivery and support 131 | 1.0 | .90 | .90 |

TABLE 2
(Reference FIG. 9)
Calibration Factor

| | |
|---|---|
| Ground Benign (Lab) | 28 |
| Ground mixed RF | 40 |
| Ground mobile EO | 56 |
| Ground mobile RF | 177 |
| Naval Unsheltered | 177 |
| Airborne Uninhabited recon RF | 177 |
| Airborne Inhabited (Fighter)(EO) | 56 |
| Airborne Inhabited (Fighter)(RF) | 177 |
| Airborne rotary wing | 56 |
| Airborne Strategic | 177 |
| Missile Launch | 220 |
| Battlefield Command and Control | 116 |
| Space flight unmanned | 600 |

1. A method for estimating the cost of completion at the end of a first time interval of a new program using a plurality of tasks for completion of said new program, said new program having program phases and new elements, said method comprising the steps of:
making an initial cost allocation for each of said tasks within said new program;
tailoring said cost allocation for said program phases to obtain a normalized value;
computing a schedule aggressiveness;
computing a requirements volatility;
computing a complexity, said complexity identifying new elements within said new program;
combining said normalized value, said schedule aggressiveness, said requirements volatility, and said complexity to extrapolate an end cost for each of said tasks for said new program from said initial allocation, said end cost estimated for the end of said first interval;
summing said end cost for each of said tasks to obtain a first value,
adjusting said first value using a resource needs ratio and a calibration factor to arrive at an estimated cost of completion of said new program at the end of said first interval.

2. A method as described in claim 1 wherein said said schedule aggressiveness, said requirements volatility, said complexity and said factor are updated in response to said estimated cost of completion of said new program at the end of said first interval for computing a next cost of completion at the end of a next interval, said next interval following said first interval.

3. A method as described in claim 1 wherein said schedule aggressiveness is computed from a schedule slip, said schedule slip derived from a manpower parameter, a facilities parameter, a process time parameter, and an invention parameter.

4. A method as described in claim 1 wherein said requirements volatility is computed from a form parameter, a fit parameter and a function parameter.

5. A method as described in claim 1 wherein said complexity is computed from the number of subsystems to be integrated as part of said new program.

6. A method as described in claim 1 wherein said factor is computed from said old elements reused within said new system and learning curves associated with said old elements.

7. A method as described in claim 1 wherein said tasks comprise one or more chosen among a Management plan, a System design, a System analysis, a Specification and interface, a Status Report and Revisions, an Assembly, Instrumentation and Test Requirements Plans, and Procedures, a Test Equipment Facilities and Delivery, an Assembly Integration and Test, a Validation, and a Post delivery and support.
